(19) United States
(12) Patent Application Publication
(10) Pub. No.: US 2012/0200281 A1
(43) Pub. Date: Aug. 9, 2012

(54) Three-Dimensional Power Supply Module Having Reduced Switch Node Ringing

(75) Inventors: Juan A. HERBSOMMER, Schnecksville, PA (US); Osvaldo J. LOPEZ, Annandale, NJ (US); Jonathon A. NOQUIL, Bethlehem, PA (US)

(73) Assignee: TEXAS INSTRUMENTS INCORPORATED, Dallas, TX (US)

(21) Appl. No.: 13/021,969

(22) Filed: Feb. 7, 2011

(51) Int. Cl. G05F 3/02

(52) U.S. Cl. 323/311

(57) ABSTRACT

A high frequency power supply module (800) of a synchronous Buck converter having the control die (810) directly soldered drain-down to the pad (801) of a leadframe; pad (801) is connected to V_{IN} and the V_{IN} connection to control die (810) exhibits vanishing impedance and inductance, thus reducing the amplitude and duration of switch node voltage ringing by more than 90%. Consequently, the input current enters the control die terminal vertically from the pad. The switch node clip (840), topping the control die (810), is designed with an area large enough to place the sync die (820) drain-down on top of the control die; the current continues to flow vertically through the converter stack. The active area of the sync die is equal to or greater than the active area of the control die; the physical area of the sync die is equal to or greater than the physical area of the control die. The source terminal of sync die (820) is connected to ground by clip (860) designed to act as a heat spreader.

### FIELD OF THE INVENTION

The present invention is related in general to the field of semiconductor devices and processes, and more specifically to the system structure and fabrication method of a power supply module having high efficiency and operating at high frequency with reduced switch node ringing.

### DESCRIPTION OF RELATED ART

Among the popular families of power switching devices are the DC-DC power supply circuits, especially the category of Switched Mode Power Supply circuits. Particularly suitable for the emerging power delivery requirements are the synchronous Buck converters with two power MOS field effect transistors (FETs) connected in series and coupled together by a common switch node. In the Buck converter, the control FET die, also called the high side switch, is connected between the supply voltage V_{IN} and the LC output filter, and the synchronous (sync) FET die, also called the low side switch, is connected between the LC output filter and the ground (the sync FET works as a synchronous rectifier substituting for a free wheeling diode). The converter also includes a driver circuit and a controller circuit.

The inductor of the output circuitry serves as the energy storage of the power supply circuit. A typical inductor should be about 300 to 400 nH to reliably maintain a constant output voltage V_{OUT}.

Some power switching devices are built with the power MOSFETs, the driver circuit, the controller circuit as separate dies. Each die is typically attached to a rectangular or square-shaped pad of a metallic leadframe and with the pad surrounded by leads as output terminals. The leads may be shaped without cantilever extensions, and arranged in the manner of Quad Flat No-Lead (QFN) or Small Outline No-Lead (SON) devices. The electrical connections from the dies are provided by bonding wires. Such assembly is typically packaged in a plastic package and the packaged components are employed as discrete building blocks for board assembly of power supply systems.

In other power switching devices, the power MOSFETs and the driver-and-controller die are assembled side-by-side on a leadframe pad, which in turn is surrounded on all four sides by leads serving as device output terminals. The leads may also be shaped in QFN or SON fashion.

In some recently introduced advanced assemblies, copper clips are used to substitute for connecting wires. These clips are wide and introduce less parasitic inductance.

In another recently development, the control FET and the sync FET are assembled vertically on top of each other in a stack, with the physically larger-area die of the two attached to the leadframe pad, and with clips providing the connections to the switch node and the stack top. In this package, the sync FET chip is assembled onto the leadframe pad with the source terminal soldered to the leadframe pad. The control FET chip has its source tied to the drain of the sync die, forming the switch node, and its drain connected to the input supply V_{IN}. A clip inserted between the two FETs connects to the switch node. The pad is at ground potential and serves as a heat spreader. An elongated clip on the stack top is connects the drain terminal of the control FET to input supply V_{IN}.

A typical converter described in the last paragraph is depicted in FIG. 1, generally designated 100. The control FET 110 is stacked upon a synchronous (sync) FET 120. The control FET die 110 has a smaller area relative to sync FET die 120. A QFN metal leadframe has a rectangular flat pad 101. The leads 102a and 102b are positioned in line along two opposite sides of the pad. The stacking of the FET dies is in a source-down configuration. The source of sync FET 120 is soldered to the leadframe pad 101 by solder layer 121. A first clip 140, soldered by solder layer 122 on the drain of sync FET 120, has the source of control FET 110 attached by solder layer 111. The first clip 140 thus serves as the switch node terminal of the converter. A second clip 160 is connected by solder layer 112 to the drain of control FET 110. Second clip 160 is attached to lead 102b of the leadframe and thus connected to the input supply V_{IN}. This converter can operate efficiently at a frequency of 500 kHz up to 1 MHz.

FIG. 2 is an electrical circuit representation of the synchronous Buck converter assembly of FIG. 1. In FIG. 2, gate 210b is depicted as connected to a lead by wire bond, which correlates with parasitic inductance L_{GATE} (211) of about 1.94 nH and parasitic impedance R_{GATE} (212) of about 26 mΩ. The parasitic impedance R_{SOURCE} (213) of source 210a is virtually zero because of the source-down assembly of control FET 210 onto first clip 140. The parasitic inductance of source 210a is also small because of the source-down assembly.

FIG. 2 further lists typical parasitic inductances and impedances of sync FET 220 to leadframe pad 101. Due to the connection of source 220a to the pad by soldering, the parasitic resistance R_{SOURCE} (224) of the connection is small (about 0.001 mΩ). The parasitic impedance R_{DRAIN} (221) of drain 220c is virtually zero due to the solder attachment of sync FET 220 onto first clip 140; parasitic inductance of drain 220c is also low. Gate 220b is connected to a lead by wire bond and thus correlated with parasitic inductance L_{GATE} (223) of about 1.54 nH and parasitic impedance R_{GATE} (222) of about 22 mΩ.

As depicted in FIG. 2, the load current of the converter flows from switch node 240 through first clip 140, which is attached to a respective lead of the leadframe, to an output inductor a V_{OUT} (270). Along first clip 140, the parasitic impedance R_{OUT} (272) is about 0.2 mΩ, and the parasitic inductance L_{OUT} (271) is about 0.45 nH. FIG. 2 further shows the gate return of the control FET connected from switch node 240 to a respective lead of the leadframe. Since the connection is by wire bond, the connection contributes a parasitic inductance 241 of about 1.54 nH and an parasitic impedance 242 of about 22 mΩ.

### SUMMARY OF THE INVENTION

Applicants observed that during the initial stages of the ON cycle of a typical system as depicted in FIG. 1, there is excessive ringing associated with the switch node voltage for a time interval of about 50 ns with a maximum of about 25 V. This peak voltage may approach or exceeds the breakdown voltage of the MOSFETs used in the system and thus for many applications the amplitude and the time duration of the ringing are unacceptable.

After a detailed analysis, Applicants discovered that the root cause of the excessive ringing is associated with the excessive parasitic impedance and inductance at the input node of the converter, which causes energy to exchange between it and the output circuitry, and which manifests as ringing at the output node. Furthermore, Applicants discovered that a significant contributor to the parasitic inductance and impedance at the input node is the elongated clip that connects the drain of the control FET to the input supply V_{IN} at the leadframe terminal 102b.

Applicants further discovered that even though the elongated clip is made of highly conductive material such as copper, it is so configured in the converter that the input current that flows between the drain of the control FET and the leadframe terminal must flow the length of the clip, including the neck portion 161, and through the narrow cross section of the clip. Applicants determined that in such a converter, the clip typically adds 600 pH of inductance and 0.5 mΩ of impedance at the input node. Applicants solved this problem by connecting the input terminal of the converter directly to the leadframe pad thereby eliminating the parasitic effect associated with the clip from the input node of the converter circuit. This can be accomplished, for example, by construct the converter with a drain-down FET as the control FET and places the drain terminal directly on a metal pad that is attachable to the external circuit board so the input current flows perpendicularly and vertically from the Vᵢₙ terminal to the drain of the control FET. This results in a current path between practically without any parasitic inductance or impedance. The switch node clip, topping the control die, is designed with an area large enough to place the sync die drain-down on top of the control die so that the current continues to flow vertically through the converter stack. The source terminal of the sync die is connected to ground by a second clip. This embodiment is tested to reduce the amplitude and duration of the switch node voltage ringing by more than 90%. This and other embodiments of the invention will be described in more detail later with the aids of the associated drawing figures.

### BRIEF DESCRIPTION OF THE DRAWINGS

FIG. 1 depicts a cross section of a synchronous Buck converter assembled according to prior art, wherein a large-area sync FET die is attached to a leadframe pad and topped by a small-area control FET die; the latter is connected by an elongated clip to leads.

FIG. 2 is Applicants' circuit diagram representation of the synchronous Buck converter shown in FIG. 1.

FIG. 3 is a diagram plotting the switch node voltage (in volt) as a function of time (in nanosecond) after onset of a synchronous Buck converter as shown in FIG. 2.

FIG. 4 displays the amplitude of switch node voltage ringing (in volt) of a synchronous Buck converter as a function of the parasitic input induction (in picohenry).

FIGS. 5A, 5B and 5C display the structure of a synchronous Buck converter module assembled according to an embodiment of the invention.

FIG. 5A is a top view through a transparent encapsulation of the module.

FIG. 5B is a cross section view of the module of FIG. 5A along a cut line of the module.

FIG. 5C a cross section view of the module of FIG. 5A along another cut line perpendicular to the cut line of FIG. 5B.

FIG. 6 is Applicants' circuit diagram representation of the synchronous Buck converter shown in FIGS. 5A, 5B, and 5C.

FIG. 7 is a diagram plotting the switch node voltage (in volt) as a function of time (in nanosecond) after onset of a synchronous Buck converter as shown in FIGS. 5A, 5B, and 5C.

FIGS. 8A, 8B and 8C display the structure of a synchronous Buck converter module assembled according to another embodiment of the invention.

FIG. 8A depicts a top view through a transparent encapsulation of the module.

FIG. 8B depicts a cross section view of the module of FIG. 8A along a cut line of the module.

FIG. 8C depicts a cross section view of the module of FIG. 8A along another cut line perpendicular to the cut line of FIG. 8B.

FIGS. 9A, 9B and 9C display the structure of yet a synchronous Buck converter module assembled according to another embodiment of the invention.

FIG. 9A is depicts a top view through a transparent encapsulation of the module.

FIG. 9B depicts a cross section view of the module of FIG. 9A along a cut line of the module.

FIG. 9C depicts a cross section view of the module of FIG. 9A along another cut line perpendicular to the cut line of FIG. 9B.

FIGS. 10A, 10B and 10C display the structure of a synchronous Buck converter module assembled according to yet another embodiment of the invention.

FIG. 10A depicts a top view through a transparent encapsulation of the module.

FIG. 10B depicts a cross section view of the module of FIG. 10A along a cut line of the module.

FIG. 10C depicts a cross section view of the module of FIG. 10A along another cut line perpendicular to the cut line of FIG. 10B.

### DETAILED DESCRIPTION OF THE PREFERRED EMBODIMENTS

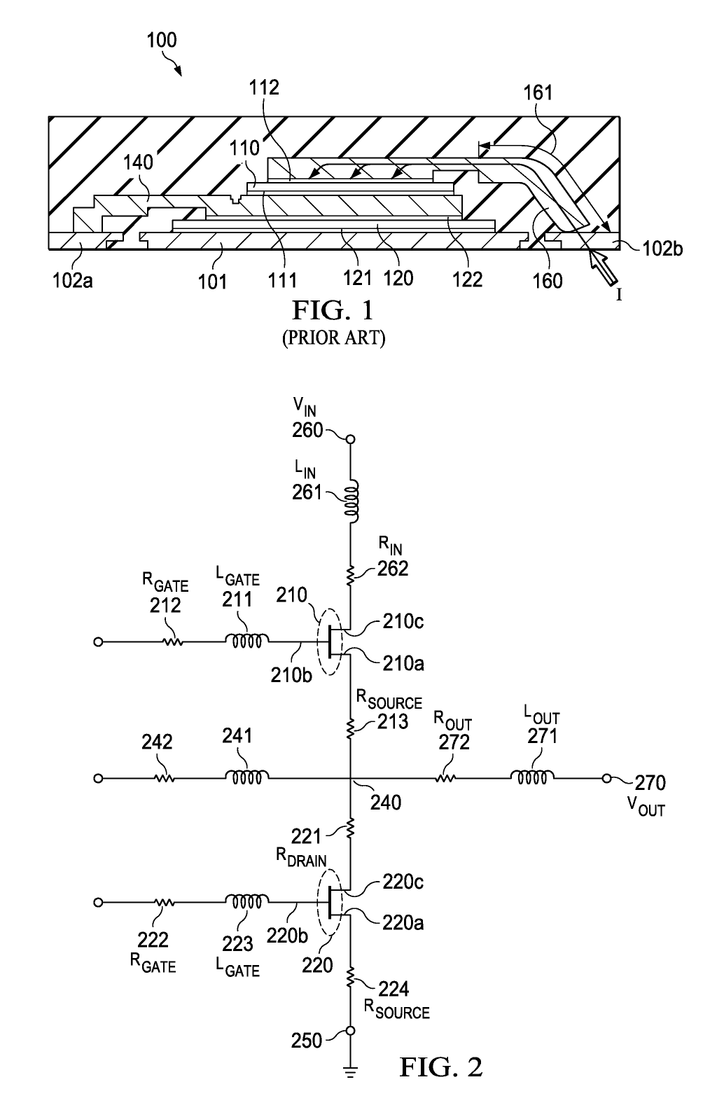

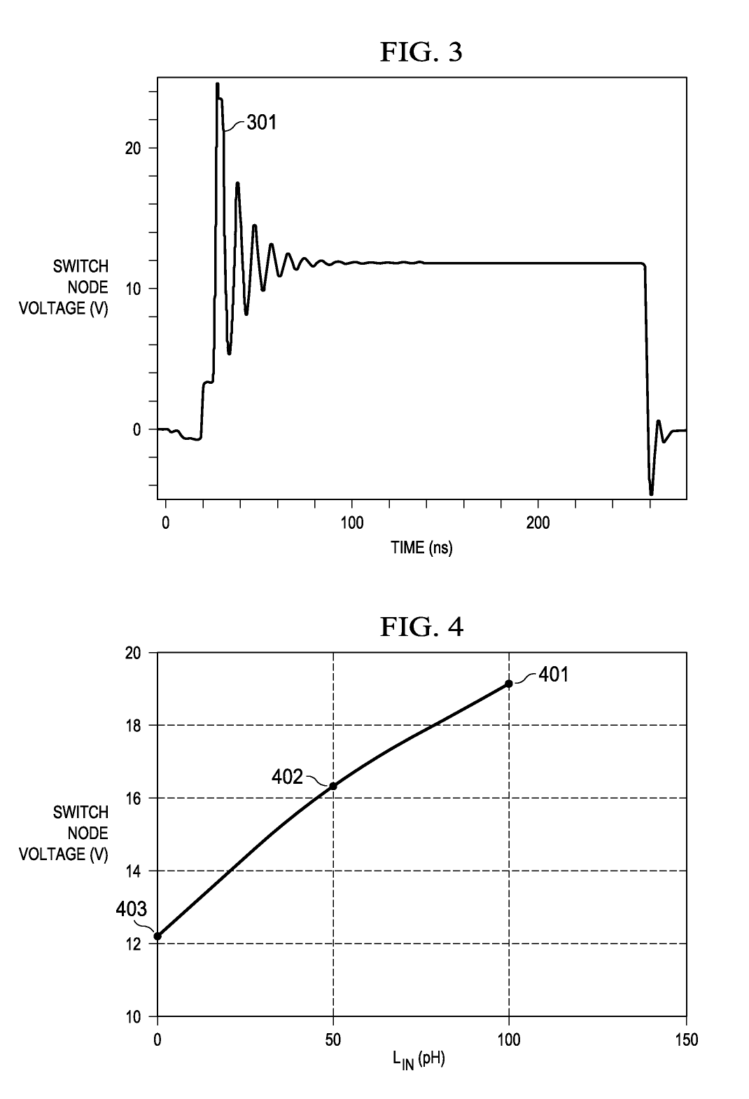

When an exemplary synchronous Buck converter as shown in FIG. 1 is in operation, onsets of the switch node voltage V_{SW} as a function of time have been observed as plotted by simulated waveform 301 in FIG. 3. The switch node voltage V_{SW}, measured in volt, is displayed as a function of time (in nanosecond). As FIG. 3 shows, the voltage swings periodically through rapid excursions up to 25 V, before it is damped to its final steady value of 12 V. This so-called ringing behavior of the switch node voltage lasts between 60 and 80 ns. For many converter applications, this strong and long ringing of the switch node voltage is not acceptable.

In a detailed analysis, Applicants discovered that the root cause of these oscillations of the switch node voltage is the high parasitic inductance L_{IN} (600 pH, designated 261 in FIG. 2) and parasitic impedance R_{IN} (0.5 mΩ, designated 262 in FIG. 2) of the elongated clip, designated 160 in FIG. 1. The clip has an elongated extension for connecting the control input terminal to the input supply V_{IN}. As a result, the current from V_{IN} to the input terminal of control die (110) flows laterally through the length of clip 160, which has parasitic inductance and impedance. FIG. 4 shows data and interpolated values of the turn-on switch node voltage V_{SW}, measured in volt, as a function of the parasitic inductance L_{IN}, measured in picohenry. At a parasitic input inductance L_{IN} of 100 pH (measurement 401), switch node voltage V_{SW} experiences excursions of more than 19 V. As mentioned, in the circuit of FIG. 2, the parasitic input inductance L_{IN} may be 600 pH. This will cause the switch node voltage V_{SW} to reach excursions up to 25 V. In FIG. 4, reducing L_{IN} to 50 pH (data point 402), still causes switch node voltage swings of more than 16 V.

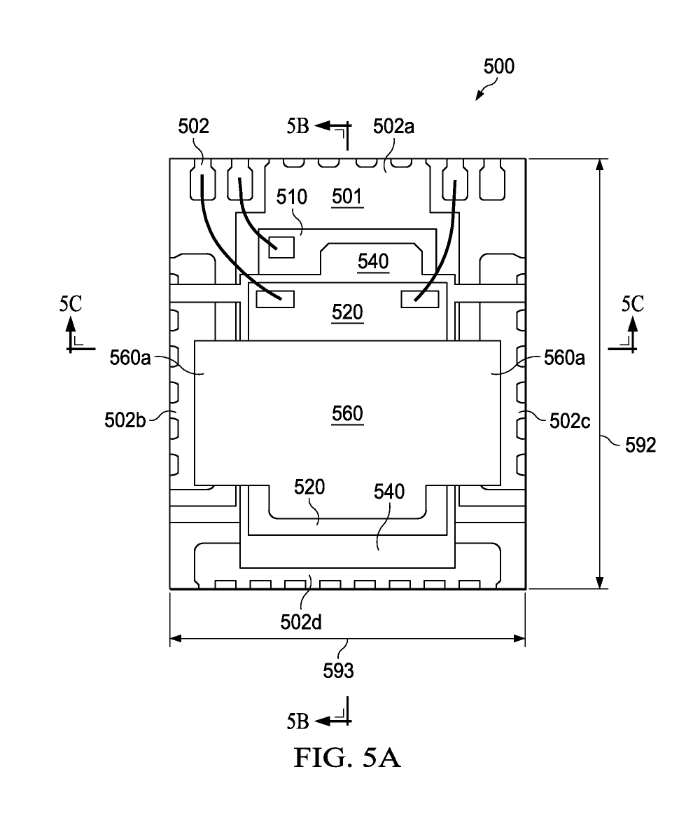

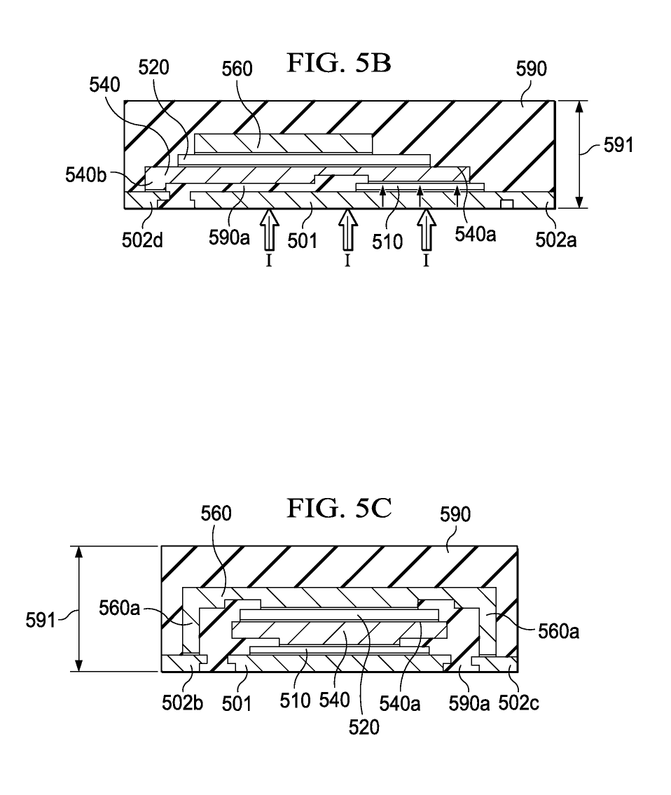

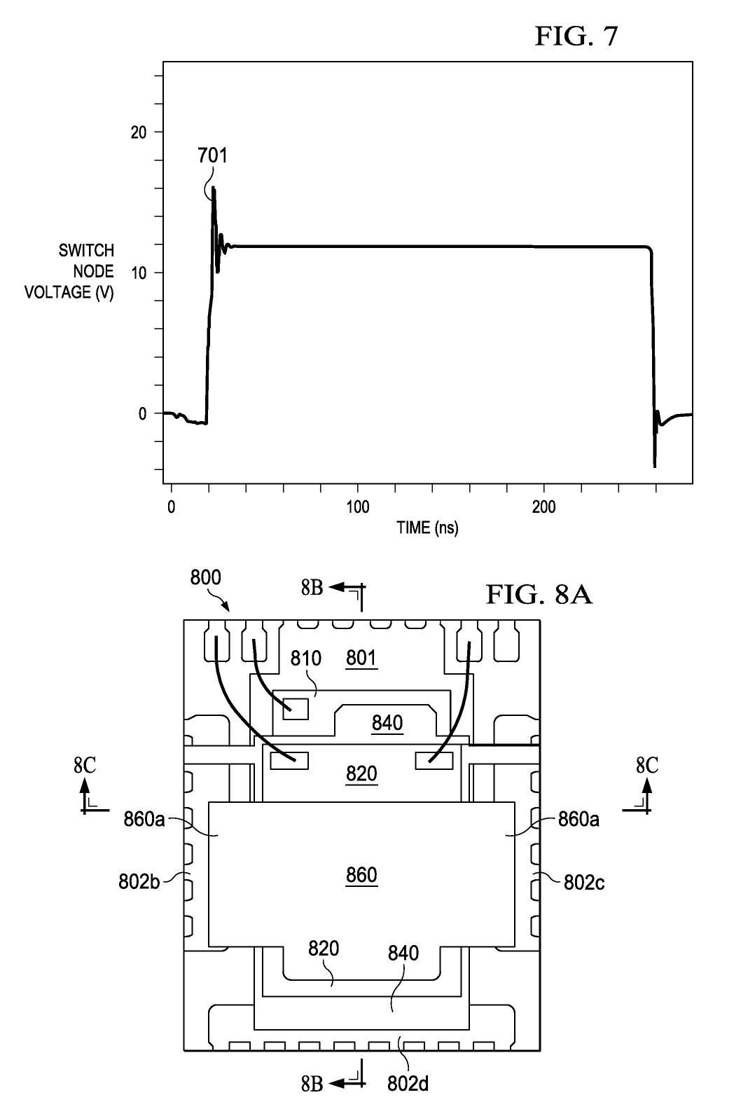

FIGS. 5A, 5B, and 5C depict one solution to the above problem. The converter depicted in the drawings has its input current flowing vertically from the pad 501 to the drain terminal of the control FET 510 without passing through any element that has substantial parasitic impedance or inductance. The control FET is directly attached to the leadframe pad which is connected to V_{IN}. The control FET in this converter is a drain-down n-channel MOSFET. Consequently, the input current (I) enters the control die drain terminal vertically from the pad; for solder attachments, the input current can reach the drain of the control die with vanishing impedance and inductance. The sync die is placed on top of the control die and attached drain down to the source of the control die. The current thus continues to flow vertically through the converter stack. The source terminal of the sync die is connected to ground by a clip designed to act as a heat spreader. As a result, the ringing of the switch node voltage is reduced by more than 90% of time duration and more than 75% of amplitude (more detail see FIG. 7).

In the top view through a transparent encapsulation compound, FIG. 5A depicts cutaway lines for the cross sections of FIGS. 5B and 5C. Converter 500 has a sync MOSFET die 520 stacked upon a control MOSFET die 510. Since the resistance R_{ON} of the ON state is inversely proportional to the active die area, the duty cycle of the synchronous Buck converter determines the ratio of the active areas needed for the control FET relative to the sync FET. In the exemplary module of FIGS. 5A, 5B, and 5C, the anticipated duty cycle is low most of the time (<0.5). Therefore the control FET is off and not conducting during most of the operation; and the sync FET is conducting most of the cycle time. To reduce conduction losses of the Buck converter, P_{LOSS}=I²R_{ON}, it would be favorable to have the sync FET die 520 with an active area equal to or larger than the active area of control FET die 510. Consequently, the sync die 520 also has a physical area equal to or larger than the physical area of the control die 510.

FIGS. 5A, 5B, and 5C further depict a metal leadframe with a general QFN-type configuration with a rectangular flat device assembly pad (DAP) 501, destined to become the input terminal of the input current (I) from V_{IN}. The leads of the leadframe are arranged parallel to the four sides of rectangular pad 501. Discrete leads are designated 502; other leads are grouped in sets: Set 502a is connected to pad 501; sets 502b and 502c serve as terminals to electrical ground and path to thermal energy (heat) transfer; and set 502d serves as terminal to the switch node and the output current. It should be noted that other embodiments may have different lead configurations, especially for specific heat distribution needs.

As mentioned, in the example of FIGS. 5A, 5B, and 5C, control die 510 has an area equal to or smaller than sync die 520. Since the embodiment of n-type conductivity channel dies requires the control die to be assembled drain-down on the leadframe pad, the small control die needs to be positioned vertically under the large sync die in the stacked assembly. Consequently, switch clip 540 (also referred to as the first clip), which connects the source of control die 510 to the drain of sync die 520, maybe designed so that it extends the solderable area of its top side 540a to accommodate the large-area sync die 520. A preferred fabrication method for switch clip 540 involves a half-etch technique, which allows the formation of a beam-like ridge (prop) 540b protruding from one side of first clip 540 to facilitate the attachment of first clip 540 to lead set 502d of the leadframe (see FIG. 5B).

In the converter assembly with drain-down stacked FETS, the source terminal of sync die 520 is positioned on top of the stack and has to be electrically connected to ground. The connecting second clip 560 is designed to conduct most of the operational heat created by the operating converter to a heat sink in the substrate. Consequently, the second clip 560 of this embodiment has a large metal area acting as heat spreader and preferably two elongated ridges (props) 560a (see FIG. 5C) along opposite clip sides in order to conduct the heat to leads 502b and 502c and from there to heat sinks in the substrate. In other embodiments with different configuration of the leads, clip 560 maybe designed to have three ridges for enhanced heat removal from the converter; in yet other embodiments, one ridge 560a may suffice. Ridges 560a are formed tall enough so that they can be soldered to the lead sets 502b and 502c on opposite sides of pad 501. The preferred method of fabricating second clip 560 with ridges 560a is a half-etching technique applied to a metal sheet.

The stacked MOSFETS are preferably encapsulated in a protective packaging compound 590 to form a module. The preferred encapsulation method is a molding technique. In the embodiment depicted in FIGS. 5B and 5C, the thickness 591 of the molded module is about 1.5 mm. Since switch clip 540, as mentioned above, is preferably fabricated by a half-etch technique, it is advantageous to fill any space opened by the half-etch preparation, such as gaps 590a, with encapsulation compound in order to enhance the robustness of the encapsulated module. In FIG. 5A, the embodiment 500 has lateral dimensions of the molded package as follows: length 592 about 6 mm, width 593 about 5 mm.

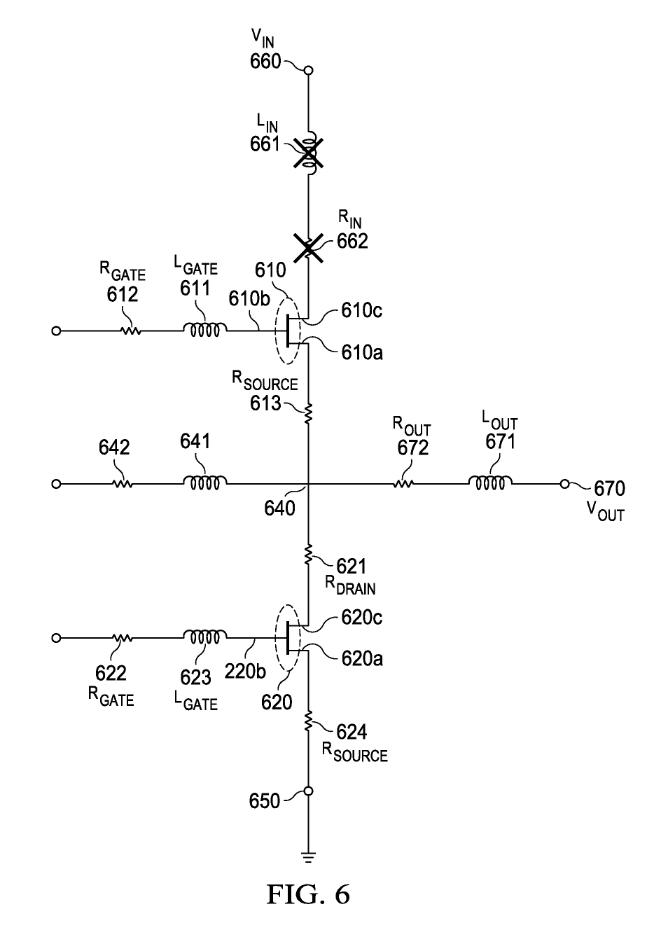

FIG. 6 is a circuit diagram representation of the exemplary synchronous Buck converter as depicted in FIGS. 5A, 5B, and 5C. The input current flowing from supply V_{IN} (660) to the drain 610c of control FET 610 flows vertically through the thickness of leadframe pad (501 in FIGS. 5A, 5B, and 5C), resulting in near zero parasitic inductance L_{IN} (661) and parasitic impedance R_{IN} (662).

Further depicted in FIG. 6, gate 610b is connected to a lead of the leadframe by wire bond and thus has parasitic inductance L_{GATE} (611) of about 1.94 nH and parasitic impedance R_{GATE} (612) of about 26 mΩ. The parasitic impedance R_{SOURCE} (613) of source 610a of control FET 610 is virtually zero because the source 610a is directly soldered onto the first clip 540, which functioning as switch node 640; likewise any parasitic inductance of source 610a is also virtually negligible.

FIG. 6 further lists the parasitics in conjunction with the drain-down sync FET 620 connected to the switch node and the connection of its source 620a to ground 650. The parasitic impedance R_{SOURCE} (624) and the parasitic resistance along second clip to supply voltage V_{IN} is not zero but its effect to the input current is negligible. The parasitic impedance R_{DRAIN} (621) between the drain 620c and the first chip is virtually zero due to the attachment of sync FET 620 onto first clip 540 (switch node 640); parasitic inductance of drain 620c is also virtually zero.

Gate 620b is tied to a lead of the leadframe by wire bond and thus has parasitic inductance L_{GATE} (623) of about 1.54 nH and parasitic impedance R_{GATE} (622) of about 22 mΩ. In FIG. 6, the load current of the converter flows from switch node 640 through first clip (540 in FIGS. 5A, 5B, and 5C), attached to a respective lead of the leadframe, to an output inductor (not shown in FIG. 6) and V_{OUT} (670). Along first clip 540, the parasitic impedance R_{OUT} (672) is about 0.2 mΩ, and the parasitic inductance L_{OUT} (671) is about 0.45 nH. FIG. 6 further depicts the gate return of the control FET connected from switch node 640 to a respective lead of the leadframe. Since the connection is by wire bond, the connection contributes a parasitic inductance 641 of about 1.54 nH and a parasitic impedance 642 of about 22 mΩ.

When an exemplary synchronous Buck converter as shown in FIGS. 5A, 5B, and 5C is in operation, the waveform of the onsets of the switch node voltage V_{SW} 701 as a function of time maybe plotted as in FIG. 7. As FIG. 7 shows, the voltage swings through a couple of minor excursions up to 16.3 V, before it is quickly damped to its final steady value of 12 V. This type of ringing behavior of the voltage lasts between 10 and 15 ns and is thus brief and mild.

Other simulations and data have demonstrated that the efficiency of a synchronous Buck converter assembled according to FIGS. 5A, 5B, and 5C can reach a value of 89.5%, while a converter assembled according to FIG. 1 has an efficiency of only 88.5%. That is almost 8 percent reduction in loss of efficiency.

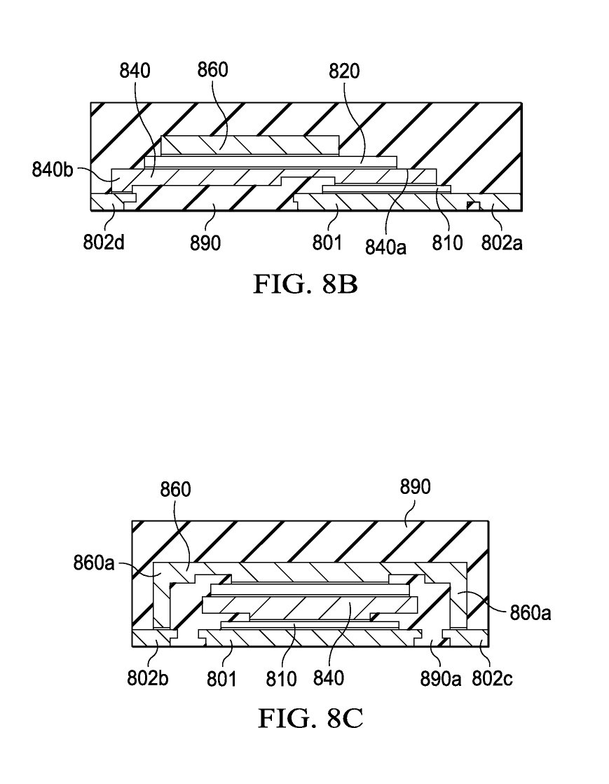

Another embodiment of the invention, generally designated 800 and depicted in FIGS. 8A, 8B, and 8C, is characterized by a leadframe pad 801 with an area reduced to be comparable to the area of the control die 810. As a comparison of FIG. 8B to FIG. 5B illustrates, due to the reduced amount of pad metal, more encapsulation compound 890 can be used. The increased amount of encapsulation compound provides increased robustness in temperature excursions and moist ambient for module 800. This measure reduces the risk of delamination between compound and metal, or of facture of the compound.

As depicted in FIG. 8B, first clip 840 is designed so that it extends the solderable area of its top side 840a to accommodate the large-area sync die 820. A preferred fabrication method for first clip 840 involves a half-etch technique, which allows the formation of a beam-like ridge 840b protruding from one side of first clip 840 to facilitate the attachment of first clip 840 to lead set 802d of the leadframe. The second clip 860 is designed to conduct most of the operational heat created during the operation of the converter to a heat sink in the substrate. Consequently, second clip 860 of the embodiment has a large metal area acting as heat spreader and preferably two elongated ridges 860a along opposite clip sides to conduct the heat to leads 802b and 802c and from there to heat sinks in the substrate. In other embodiments, clip 860 is designed to have three ridges for enhanced heat removal from the converter; in other embodiments, however, one ridge may suffice. Ridges 860a are formed tall enough so that they can be soldered to the lead sets 802b and 802c on opposite sides of pad 801. The preferred method of fabricating second clip 860 with ridges 860a is a half-etching technique applied to a metal sheet.

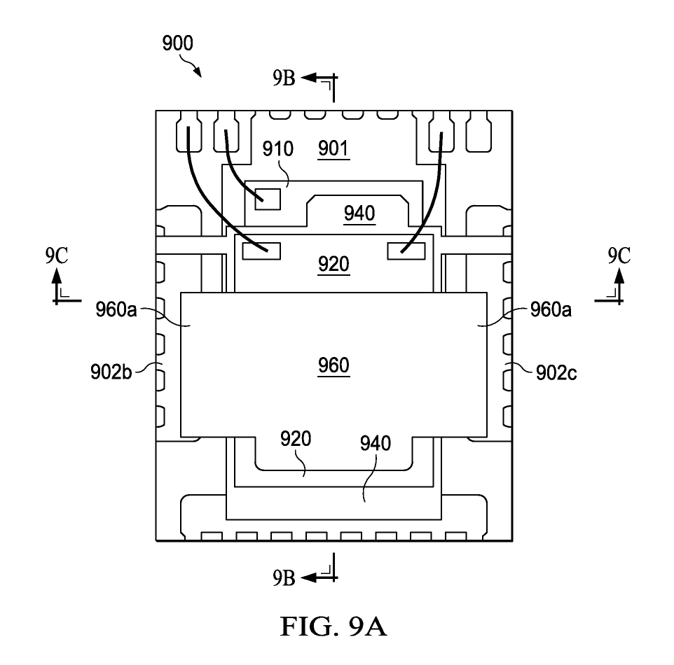

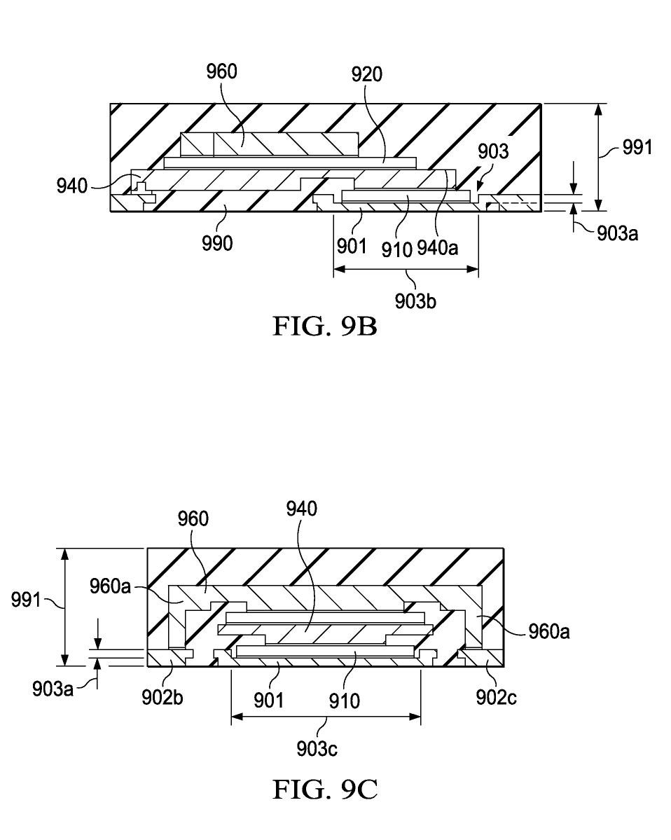

Yet another embodiment of the invention, generally designated 900 and depicted in FIGS. 9A, 9B, and 9C, includes a leadframe pad 901 of an area similar to the pad area of the embodiment in FIG. 8, but with an indented recess 903 in the pad area. By a half-etching technique, rectangular recess 903 is created with a depth 903a and with lateral dimensions 903b and 903c so that the rectangular control die 910 can be placed in the indented recess. The sync die is designated 920. As a consequence, first clip 940 does not require protruding ridges for attachment to the leadframe leads, and rather can remain a substantially flat plate and thus support the ongoing trend for reducing the overall module thickness. In module 900 with encapsulation compound 990, thickness 991 is only 1.3 mm as compared to thickness 591 of 1.5 mm of the exemplary module in FIG. 5. In FIGS. 9A and 9C, the second clip 960 is designed to conduct most of the heat created by the operating converter to a heat sink in the substrate. Consequently, second clip 960 of the embodiment has a large metal area acting as heat spreader and preferably two elongated ridges 960a along opposite clip sides conducting the heat to leads 902b and 902c and from there to heat sinks in the substrate. In other embodiments with different configurations of the leads, clip 960 is designed to have three ridges for enhanced heat removal from the converter or in yet other embodiments, one ridge.

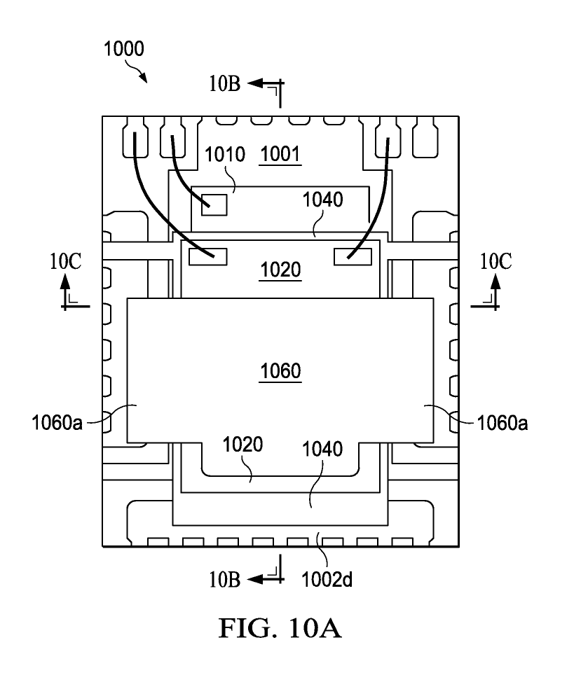

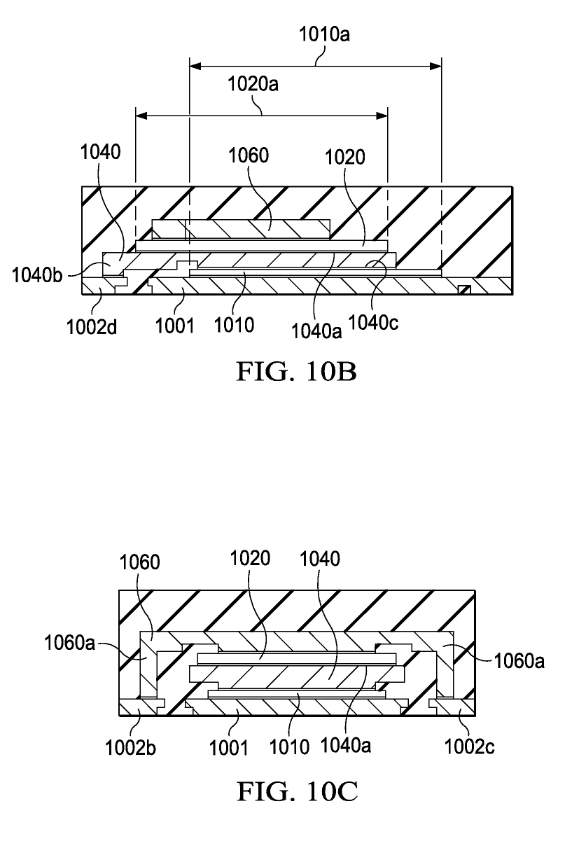

FIGS. 10A, 10B, and 10C illustrate yet another embodiment, generally designated 1000 and intended for high duty cycle operation. Embodiment 1000 is characterized by the substantially equal areas of control die 1010 and sync die 1020. As an example, the lateral dimensions 1010a and 1010b in FIG. 10B may each be 3.5 mm. Since the n-type conductivity channel dies is more readily assembled with drain down on leadframe pad 1001, control die 1010 may be positioned vertically under sync die 1020 in the stacked assembly. Consequently, switch clip (first clip) 1040, connecting the source of control die 1010 with the drain of sync die 1020, maybe designed so that it has a solderable surface 1040a to accommodate sync die 1020 and a solderable surface 1040c to accommodate control die 1010. A preferred fabrication method for switch clip 1040 involves a half-etch technique, which allows the formation of the appropriate surface areas as well as a beam-like ridge (prop) 1040b protruding from one side of first clip 1040 to facilitate the attachment of first clip 1040 to lead set 1002d of the leadframe (see FIG. 10 B). In the converter assembly with drain-down stacked FETS, the source terminal of sync die 1020 is positioned on top of the stack and has to be electrically connected to ground potential. The connecting second clip 1060 is designed to conduct most of the operational heat created by the operating converter to a heat sink in the substrate. Consequently, second clip 1060 of the embodiment has a large metal area acting as heat spreader and two (or even three) elongated ridges 1060a along opposite clip sides conducting the heat to leads 1002b and 1002c and from there to heat sinks in the substrate.

While this invention has been described in reference to illustrative embodiments, this description is not intended to be construed in a limiting sense. Various modifications and combinations of the illustrative embodiments, as well as other embodiments of the invention, will be apparent to persons skilled in the art upon reference to the description. As an example, the invention applies not only to field effect transistors, but also to other suitable power transistors.

As another example, the high current capability of the power supply module can be further extended, and the efficiency further enhanced, by leaving the top surface of the second clip un-encapsulated so that the second clip can be connected to a heat sink, preferably by soldering. In this configuration, the module can dissipate its heat from both surfaces to heat sinks.

It is therefore intended that the appended claims encompass any such modifications or embodiments.

We claim:

1. A power supply module having an electrical input terminal and a ground terminal, comprising: a leadframe including an die pad and leads, of which the pad is the electrical input terminal and at least on lead is a ground terminal; and
a synchronous Buck converter including a control FET die, a by a synchronous FET die stacked on top of the control FET die;
the control FET die having a first physical area, a first active area, a first source terminal on a first side of the die, and a first drain terminal on a second side of the die, opposite the first side;
the synchronous FET die having a second source terminal on a first side of the die, and a second drain terminal on a second side of the die, opposite the first side; and
the first drain terminal of the control FET die directly affixed to the die pad, the second source terminal of the synchronous FET die connected to the ground terminal by a metal clip.

2. The power supply module of claim 1 wherein the synchronous FET die has a second physical area not smaller than the first physical area, a second active area not smaller than the first active area, and the second drain terminal attached to the first source terminal.

3. The power supply module of claim 2 wherein the control FET and the synchronous FET are n-type MOSFETs.

4. The power supply module of claim 3 wherein the leads are positioned in line with sides of the pad.

5. The power supply module of claim 4 further including a first metal clip operable as the switch node terminal of the converter soldered onto the first source terminal and the second drain terminal and having a ridge connecting to respective leads.

6. The power supply module of claim 1, in which the metal clip is soldered onto the second source terminal and having one or more ridges connecting to respective leads.

7. The power supply module of claim 6, in which the control FET has a first gate terminal and the synchronous FET has a second gate terminal.

8. The power supply module of claim 7 further including wire bonds connecting the first and second gate terminals to leads.

9. The power supply module of claim 8 further including a packaging compound encapsulating the converter, clips, and wire bonds, leaving un-encapsulated the surfaces of the pad and leads intended for connection to external parts.

10. A power supply module comprising a first electrical path between an external input terminal and a control field effect transistor (FET), and a second electrical path between an external ground terminal and a synchronous FET; and in which the first electrical path is less electrically resistive than the second electrical path.

11. The power supply module of claim 10, in which the second electrical path includes a metal clip.

12. The power supply module of claim 10, in which the first electrical path includes a metal pad soldered to a FET die.

13. The power supply module of claim 11, in which the metal clip contacts the external ground terminal and the synchronous FET die.

14. The power supply module of claim 13, in which the metal clip contacts the synchronous FET die at a source terminal.

15. The power supply module of claim 10, further comprising an external switch node terminal.

16. The power supply module of claim 15, in which the external switch node terminal is connected to a metal clip.

17. The power supply module of claim 16, in which the metal clip contacts both the control FET and the synchronous FET.

18. The power supply module of claim 17, in which the control FET is soldered to a first surface of the metal clip and the synchronous FET is soldered to a second surface of the metal clip.

19. The power supply module of claim 18, in which the metal clip is soldered to a source terminal of the control FET and to a drain terminal of the synchronous FET.

20. The power supply module of claim 10, further comprising an external switch node terminal and in which the external input terminal is disposed between the external switch node terminal and the external ground terminal.
